(19) United States
(12) Patent Application Publication
(10) Pub. No.: US 2024/0422653 A1
(43) Pub. Date: Dec. 19, 2024

(54) RADIO FREQUENCY DEVICES

(71) Applicant: Nordic Semiconductor ASA, Trondheim (NO)

(72) Inventors: Lorenzo AMICUCCI, Trondheim (NO); Torbjørn ØVREBEKK, Trondheim (NO)

(73) Assignee: Nordic Semiconductor ASA, Trondheim (NO)

(21) Appl. No.: 18/741,618

(22) Filed: Jun. 12, 2024

(30) Foreign Application Priority Data
Jun. 16, 2023 (GB) 2309042.6

(51) Int. Cl. H04W 48/10; H04L 5/00

(52) U.S. Cl. CPC H04W 48/10; H04L 5/0048

(57) ABSTRACT

A radio frequency communication system is provided. The system comprises a first radio frequency device and a second radio frequency device arranged to establish a communication link by exchanging radio frequency signals in which data are encoded. The first radio frequency device is arranged to broadcast a radio frequency signal in which an advertising packet is encoded, the advertising packet comprising authentication information encrypted using an advertising key. The second radio frequency device is arranged to retrieve the authentication information and use the authentication information to authenticate the communication link.

### CROSS REFERENCE TO RELATED APPLICATION

This application claims priority from Great Britain Application No. 2309042.6, filed Jun. 16, 2023, which application is incorporated herein by reference in its entirety.

### BACKGROUND OF THE INVENTION

The present invention relates to radio frequency devices and methods of communicating between said devices.

Radio communications are commonplace. Because radio communications can be intercepted relatively easily, it is desirable to secure these communications using encryption (to avoid unauthorised parties accessing the communication) and authentication (to verify the identity of the communicators).

Encryption and authentication are achieved in many radio communications by using a shared secret symmetric key, that is only known to authorised devices, to encrypt communications. Methods of sharing encryption keys to establish secure communications include out-of-band or manual key exchange (e.g. a user simply entering manually the key or information used to derive the key into one or both devices). However, this requires the devices to have suitable out-of-band (e.g. near-field communication) or user interface (e.g. keyboard/display) hardware, and may also be vulnerable to an eavesdropper who observes the entry of the key or intercepts the out-of-band exchange.

Some communication protocols utilise secure in-band key exchange protocols such as Diffie-Hellman public key exchange. These avoid out-of-band communications or user interaction and the associated hardware requirements and eavesdropping vulnerabilities. However, they do not inherently provide any authentication protection against man-in-the-middle (MITM) attacks in networks (e.g. Bluetooth networks) that do not have a separate Public Key Infrastructure to authenticate the public keys.

To mitigate MITM attacks, some radio communication protocols combine in-band key exchange with out-of-band or user confirmation steps. Bluetooth Low Energy Secure Connections protocols (e.g. as set out in the Bluetooth core specification v5.0) include several methods in which public key exchange is combined with out-of-band communications and/or user interactions with the pairing devices to establish an encrypted and authenticated communication link. For instance, one such method involves each device using the shared public keys to generate locally a numeric confirmation value which is displayed to a user on a display. The user must confirm that both devices are displaying the same value to continue with the pairing process. This approach provides authentication because an MITM attacker cannot interfere with the locally-generated confirmation values.

However, these approaches are only possible for devices having the requisite user interfaces or out-of-band communication hardware (e.g. NFC hardware). An improved approach may be desired.

### SUMMARY OF THE INVENTION

According to a first aspect of the present invention there is provided a radio frequency communication system comprising:
a first radio frequency device and a second radio frequency device arranged to establish a communication link by exchanging radio frequency signals in which data are encoded;
   wherein the first radio frequency device is arranged to broadcast a radio frequency signal in which an advertising packet is encoded, the advertising packet comprising authentication information encrypted using an advertising key, and the second radio frequency device is arranged to retrieve the authentication information and use the authentication information to authenticate the communication link.

According to a second aspect of the present invention there is provided a method of operating a radio frequency communication system comprising a first radio frequency device and a second radio frequency device, the method comprising:
the first and second radio frequency devices establishing a communication link by exchanging radio frequency signals in which data are encoded;
the first radio frequency device broadcasting a radio frequency signal in which an advertising packet is encoded, the advertising packet comprising authentication information encrypted using an advertising encryption key; and
the second radio frequency device retrieving the authentication information and using the authentication information to authenticate the communication link.

Thus, it will be appreciated by those skilled in the art that, by authenticating the communication link using authentication information broadcast in a separately-encrypted advertising packet, the second radio frequency device may avoid the need for out-of-band or user interface hardware without jeopardising the integrity of the communication link.

Even if an unauthorised MITM attacker is able to intercept the data exchanged between the radio frequency devices, they will not have access to the advertising key and thus cannot access or interfere with the authentication information. This provides mutual authentication of the first and second devices: the second radio frequency device must be genuine to be able to retrieve the encrypted authentication information, and the first radio frequency device must be genuine for the authentication information to successfully be used to authenticate the communication link. The authenticating of the communication link may be part of establishing the communication link, or it may be a separate step.

Various different types of authentication information may be used to authenticate the communication link. In a set of embodiments, the authentication information comprises an input to a cryptographic authentication process (e.g. a passkey). For instance, one or each of the first and second radio frequency devices may be arranged to use the authentication information and one or more parameters relating to the communication link (e.g. public keys of the first and second radio frequency devices) in a cryptographic function to produce a cryptographic confirmation value. The first and/or second radio frequency device may also use one or more nonce values in the cryptographic function.

The confirmation value(s) (and optionally the one or more nonce values) may then be exchanged over the communication link and checked by the other device (e.g. by repeating the cryptographic function locally) to authenticate the communication link. In such embodiments a MITM attacker does not have access to the authentication information and so cannot provide valid confirmation values. In a set of embodiments, the method comprises one or more steps of the Bluetooth LE Secure Connections Passkey Entry authentication protocol (i.e. as set out at Vol 3, Part H, Section 2 of the Bluetooth core specification v5.0), wherein the authentication information comprises a passkey. The cryptographic function used to generate the confirmation values may comprise the LE Secure Connections Confirm Value Generation Function.

In some sets of embodiments the authentication information comprises an output of a cryptographic authentication process. For instance, the first and second radio frequency devices may be arranged to generate locally a confirmation value (e.g. a numeric value) using one or more parameters relating to the communication link (e.g. public keys of the first and second radio frequency devices) in a cryptographic function. The first and/or second radio frequency device may also use one or more nonce values in the cryptographic function.

The confirmation value generated by the first radio frequency device may then be transferred to the second radio frequency device as the authentication information, and the second radio frequency device may be arranged to compare the authentication information with its locally-generated confirmation value to authenticate the communication link. Authentication may be successful if the confirmation values match. In such embodiments, a MITM attacker does not have access to the generation of either confirmation value and so cannot manipulate the confirmation values to match. In a set of embodiments, the method comprises one or more steps of the Bluetooth LE Secure Connections Numeric Comparison authentication protocol (i.e. as set out at Vol 3, Part H, Section 2 of the Bluetooth core specification v5.0), wherein the authentication information comprises confirmation values. The cryptographic function used to generate the confirmation values may comprise the LE Secure Connections numeric comparison value generation function.

In some embodiments, the authentication information comprises an input and an output of cryptographic authentication process. For instance, the first radio frequency device may be arranged to generate locally a secret value and a confirmation value produced by using said secret value and one or more parameters relating to the communication link (e.g. public keys of the first and second radio frequency devices) in a cryptographic function.

The first radio frequency device may then provide the secret value and the confirmation value as the authentication information. In such embodiments, the second radio frequency device may be arranged to re-produce a confirmation value locally using the retrieved secret value and to check if this matches the retrieved confirmation value to authenticate the communication link. In a set of embodiments, the method comprises one or more steps of the Bluetooth LE Secure Connections Out of Band authentication protocol (i.e. as set out at Vol 3, Part H, Section 2 of the Bluetooth core specification v5.0). The cryptographic function used to generate the confirmation values may comprise the LE Secure Connections Confirm Value Generation Function.

In embodiments where the authentication information comprises an input to a cryptographic authentication process, the authentication information may be generated by the first radio frequency device. This may mitigate vulnerabilities associated with using the same authentication input (e.g. passkey) for different pairing procedures. In a set of embodiments the first radio frequency device is arranged to provide different authentication information each time a communication link is established and/or periodically.

In some sets of embodiments, the cryptographic function used to produce authentication information and/or in which the authentication information is used may comprise a cryptographic hash function or a message authentication code function, e.g. based on the Advanced Encrypted Standard (AES).

The communication link may be a secure communication link (e.g. using encryption to secure data sent over the link). In other words, the communication link may end up being both encrypted and authenticated. Establishing the communication link may comprise the first and second radio frequency devices exchanging public cryptographic keys (e.g. using Diffie-Hellman key exchange). The public keys may comprise elliptic curve public keys.

As explained above, embodiments of the invention enable the communication link to be authenticated without the need for user interaction or out-of-band communications. In a set of embodiments the first and/or second radio frequency device has no user interface arranged for inputting authentication information and/or no user interface arranged for outputting authentication information. For instance, the first and/or second radio frequency device may have no user interface at all (e.g. aside from a simple on/off button). In some embodiments the first and/or second radio frequency device is an embedded device. The present invention may be particularly suitable for radio frequency devices whose normal operation (e.g. once the communication link has been established) does not involve user interaction or out-of-band communications. For instance, the first and/or second device may comprise a sensor (e.g. a temperature or a light sensor). The sensor may be arranged to transmit sensor data and/or receive control data over the communication link. The first and/or second device may comprise an Internet of Things (IoT) device (e.g. a device configured to principally or only communicate with other devices over the Internet).

In some embodiments, the second radio frequency device is arranged to authenticate the communication link automatically, e.g. without any user input. This may be convenient for securing communication links to remotely located devices, or and/or for expediting the establishment of communication links (i.e. even if one or both devices feature user interfaces). For instance, the second radio frequency device may be arranged to automatically abort the establishment of the communication link if authenticating the communication link fails.

In some embodiments some user input may be needed to authenticate the communication link. For example, authenticating the communication link may comprise the second radio frequency device providing one or more user outputs based on the authentication information and receiving one or more user responses. For instance, in embodiments where the first and second radio frequency devices may be arranged to generate locally a confirmation value and the confirmation value generated by the first radio frequency device is transferred to the second radio frequency device as the authentication information, the second radio frequency device may be arranged to output the retrieved confirmation value and the local confirmation value (e.g. to a display) and prompt a user to confirm if the values match. This may satisfy device security policies which require some form of user confirmation to form a communication link whilst avoiding the need for a user to consult both devices (which may be physically remote from each other) to compare their respective confirmation values.

Decrypting the authentication information from the advertising packet requires an advertising decryption key. The authentication information may be encrypted with symmetric encryption such that the advertising decryption key is equivalent to the advertising encryption key, although in some embodiments asymmetric encryption may be used such that the encryption and decryption keys are different. The advertising encryption key may be device-specific, i.e. unique to broadcasts from the first radio frequency device. The advertising encryption key may alternatively be product-, model- or manufacturer-specific. The advertising encryption key may be static, e.g. hard-coded in the first radio frequency device, so that each pairing process uses the same advertising encryption key. Alternatively, the advertising encryption key may be dynamic, e.g. changed every time a new paring process is initiated, or changed periodically. For instance the advertising encryption key may be selected from a pre-shared list of keys, or a new key may be shared through a separate communication channel (e.g. a cellular network). The advertising encryption and/or decryption key may be accompanied by other cryptographic inputs such as an initialization vector and/or a randomizer (i.e. a nonce).

The advertising packet may comprise a Bluetooth advertising packet such as a Bluetooth LE encrypted advertising packet (e.g. the Encrypted Advertising Data type according to the Bluetooth 5.4 Core specification). The radio frequency signal in which the advertising packet is encoded may be in one or more advertising frequency channels. The establishing of the communication link may comprise the exchange of non-advertising data packets. The advertising frequency channel(s) may be separate to frequency channels used to exchange some or all of the data for establishing the communication link (e.g. the non-advertising data packets). In other words, in a set of embodiments at least some of the radio frequency signals exchanged by the first and second radio frequency devices to establish the communication link have a carrier frequency in a first frequency range, and the radio frequency signal in which the advertising packet is encoded may have a carrier frequency in a second, different frequency range.

The radio frequency signal in which the advertising packet is encoded may be broadcast before the first and second radio frequency devices exchange any data for establishing the communication link (i.e. prior to any pairing process). In other words, the broadcasting of the radio frequency signal in which an advertising packet is encoded may occur before the first and second radio frequency devices establish a communication link. Additionally or alternatively, in some embodiments, the radio frequency signal in which the advertising packet is encoded may be broadcast at substantially the same time as the first and second radio frequency devices are exchanging data for establishing the secure communication (i.e. during the pairing process). For instance, radio frequency signal(s) in which the advertising packet is encoded may be time-interleaved with radio frequency signals for establishing the secure communication. This may necessitate the use of different frequency channels as explained above. In some embodiments, the radio frequency signal in which the advertising packet is encoded may even be broadcast after the communication link has been established (e.g. in a separate authentication step).

In a set of embodiments, the second radio frequency device is arranged to receive the advertising packet and use an advertising decryption key to decrypt and retrieve the authentication information. The second radio frequency device may be arranged to scan for advertising packets from the first radio frequency device. The second radio frequency device may comprise different radio modules for establishing the communication link and receiving the advertising packet. For instance, the second radio frequency device may comprise a first radio module arranged to establish the communication link and a second radio module arranged to receive the advertising packet from the second radio frequency device. Correspondingly, the first radio frequency device may comprise first and second radios arranged to establish the communication link and broadcast the advertising packet respectively. Alternatively, the second radio frequency device may comprise a single radio module arranged to establish the communication link and to receive the advertising packet. The first radio frequency device may comprise a single radio module arranged to establish the communication link and to broadcast the advertising packet.

The advertising decryption key (or information for deriving the advertising decryption key) may be stored to a memory of the second radio frequency device during manufacture or commissioning. For instance, the first and second radio frequency devices may be manufactured together and linked during manufacture or commissioning by storing the advertising encryption key to the first radio frequency device and storing the advertising decryption key to the second radio frequency device. Alternatively, in a set of embodiments, the second radio frequency device is arranged to receive the advertising decryption key (or information for deriving the advertising decryption key) after manufacture/commissioning (e.g. during operation). In some embodiments, the second radio frequency device may be arranged to receive the advertising decryption key (or information for deriving the advertising decryption key) through communication with another radio frequency device (e.g. through a cellular network), by user input or by some other out-of-band communication method (e.g. via a camera or NFC). For instance, the advertising decryption key or information for deriving the advertising decryption key may be printed on packaging of the first radio frequency device and input to the second radio frequency device by a user or by imaging with a camera.

However, it is not essential for the second radio frequency device itself to receive the advertising packet. Instead, a further device (e.g. which is not participating in the pairing procedure) may be used to receive and decrypt the advertising packet, which can then be forwarded to the second radio frequency device. In a set of embodiments, the radio frequency communication system comprises a third radio frequency device arranged to receive the advertising packet, decrypt the authentication information and output the authentication information. The third radio frequency device may be arranged to forward the authentication information directly to the second radio frequency device (e.g. by near-field communication). Alternatively, the third radio frequency device may simply be arranged to output the authentication information in a form suitable for a user to forward to the second radio frequency device (e.g. to output the authentication information to a display). A user may then input the authentication information to the second radio frequency device (e.g. with a keyboard, or by using a camera to image the display of the third radio frequency device).

Using a third radio frequency device to receive and decrypt the advertising packet means that the second radio frequency device does not need to know the advertising decryption key to successfully authenticate the communication link. The third radio frequency device may be thought of as acting as an out-of-band interface or user interface for the first radio frequency device. This may reduce the number of devices to which the advertising decryption key need to be distributed. For instance, a single trusted device may be used to relay authentication information to multiple second radio frequency devices.

In a set of embodiments, the communication link comprises a Bluetooth communication link, e.g. a Bluetooth Low Energy (LE) communication link. In other words, the first and second radio frequency devices may be arranged to operate according to a Bluetooth communication protocol, e.g. a Bluetooth LE protocol. Conventionally, advertising plays no active role in the authentication of a Bluetooth LE communication link. The first radio frequency device may be arranged to operate as a Bluetooth LE peripheral device and the second radio frequency device may be arranged to operate as Bluetooth LE central device, or vice-versa. Establishing the communication link may comprise one or more steps of a Bluetooth pairing procedure such as a Bluetooth LE Secure Connections pairing protocol (e.g. as set out in Vol 3, Part H, Section 2 of the Bluetooth core specification v5.0). Because the communication link is authenticated using the authentication information, the communication link may satisfy Bluetooth LE Security Level 4.

Embodiments of the present invention may advantageously be able to follow a Bluetooth LE Secure Connections pairing protocol with minimal modification, because the broadcast and retrieval of the authentication information may be considered as simply replacing user interaction and/or out-of-band communication aspects of the pairing protocol, i.e. with the rest of the protocol unchanged. Thus the present invention may be conveniently implemented without the need to develop an entirely proprietary communication or pairing protocol.

The present invention extends to computer software that, when executed by a radio frequency communication system, causes said radio frequency communication system to perform the method according to the second aspect disclosed herein. The radio frequency system may comprise one or more memories storing part or all of said software. The radio frequency system may comprise one or more processors arranged to execute part or all of said software.

The operation of the first radio frequency device is believed to be independently inventive and so according to a third aspect of the present invention there is provided a radio frequency device arranged to:
establish a communication link with another radio frequency device by exchanging radio frequency signals in which data are encoded with the other radio frequency device; and
broadcast a radio frequency signal in which an advertising packet is encoded, the advertising packet comprising authentication information for authenticating the communication link and said authentication information being encrypted using an advertising encryption key.

According to a fourth aspect of the present invention there is provided a method of operating a radio frequency device comprising:
establishing a communication link with another radio frequency device by exchanging radio frequency signals in which data are encoded with the other radio frequency device; and
broadcasting a radio frequency signal in which an advertising packet is encoded, the advertising packet comprising authentication information for authenticating the communication link and said authentication information being encrypted using an advertising encryption key.

The present invention extends to computer software that, when executed by a radio frequency device, causes said radio frequency device to perform the method according to the fourth aspect disclosed herein. The radio frequency device may comprise a memory storing said software. The radio frequency device may comprise a processor arranged to execute said software.

Features of any aspect or embodiment described herein may, wherever appropriate, be applied to any other aspect or embodiment described herein. In particular all of the preferred features of the first radio frequency device and its operation according to the first and second aspects described above may also apply to the radio frequency device and its operation of the third and fourth aspects of the invention. Where reference is made to different embodiments, it should be understood that these are not necessarily distinct but may overlap.

### BRIEF DESCRIPTION OF THE DRAWINGS

One or more non-limiting examples will now be described, by way of example only, and with reference to the accompanying figures in which:

FIG. 1 is a schematic diagram illustrating a system according to an embodiment of the present invention;

FIG. 2 is a flow diagram illustrating the operation of the system of FIG. 1;

FIG. 3 is a schematic diagram illustrating a system according to another embodiment of the present invention; and

FIG. 4 is a flow diagram illustrating the operation of the system of FIG. 3.

### DETAILED DESCRIPTION

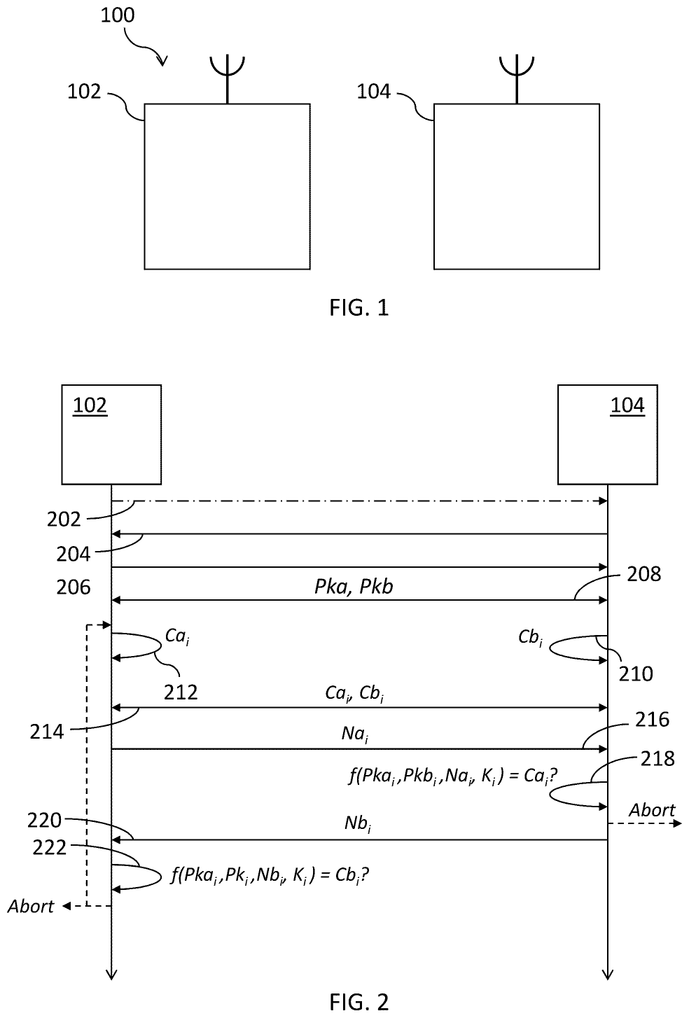

A radio frequency communication system 100 shown in FIG. 1 comprises a first radio frequency device 102 and a second radio frequency device 104. The first and second radio frequency devices 102, 104 are operable to transmit and receive signals according to a Bluetooth Low Energy wireless communication protocol.

The first and second radio frequency devices 102, 104 do not feature user interfaces (i.e. any user inputs or outputs aside from, potentially, an on/off switch). For instance, the first and second radio frequency device 102, 104 may comprise remote sensor devices with which a user does not need to interact during normal operation. In this embodiment, the only way that the first and second radio frequency devices 102, 104 can communicate with other devices is by transmitting and receiving radio frequency signals according to Bluetooth LE protocols.

Because the first and second radio frequency devices 102, 104 do not feature any meaningful user interfaces, it may be challenging to establish a fully-authenticated secure communication link between the two (i.e. that is not vulnerable to Man-In-The-Middle attacks). However, as explained below, the system 100 makes use of encrypted advertising packets to authenticate a pairing process and mitigate MITM attacks.

The pairing process will now be explained in more detail with reference to the flow diagram of FIG. 2.

In a preliminary step 202, the first radio frequency device 102 broadcasts radio frequency signals in which encrypted advertising packets are encoded. The radio frequency signals are broadcast in an advertising frequency channel (i.e. the radio frequency signals have carrier frequencies within a range defining the advertising frequency channel). The encrypted advertising packets indicate the availability of the first radio frequency device 102 and include information for establishing an encrypted communication link (pairing) with the first radio frequency device 102. The packets also contain a passkey K which will be used for authenticating the communication link.

The content of the advertising packets is encrypted with a symmetric advertising encryption key. This key is stored to the second radio frequency device 104 during manufacture. Additional information for decrypting the advertising packets such as an initialisation vector and a randomizer may also be stored to the second radio frequency device 104 during manufacture. However, it is not essential for the decryption information to be pre-stored and in some embodiments the key (and optionally additional information) is shared between the first and second radio frequency devices 102, 104 via another communication channel (e.g. a cellular network).

Because the second radio frequency device 104 knows the symmetric advertising encryption key, in step 202 the second radio frequency device 104 detects and decrypts an encrypted advertising packet from the first radio frequency device 102. The second radio frequency device 104 retrieves the pairing information and the passkey K from the encrypted advertising packet.

Once the passkey K has been exchanged using encrypted advertising, the pairing process continues in accordance with the Bluetooth LE Secure Connections Pairing Protocol (Authentication Stage 1=Passkey Entry) set out at Vol 3, Part H, Section 2 of the Bluetooth core specification v5.0. However, it is not essential for the passkey K to be exchanged using encrypted advertising before the pairing process has started. In some embodiments the passkey K may be exchanged using encrypted advertising after the start of the pairing process (i.e. step 202 may happen later in the process in other embodiments).

The pairing process continues with the first and second radio frequency devices 102, 104 exchanging radio frequency signals in which pairing data are encoded. These radio frequency signals are in non-advertising frequency channels (i.e. the radio frequency signals have carrier frequencies that are not within the range defining the advertising frequency channel).

In step 204, the second radio frequency device 104 sends a pair request to the first radio frequency device 102 (using pairing information retrieved from the encrypted advertising packet) to initiate a paring procedure.

In step 206, the first radio frequency device 102 provides a positive pair response to the pair request.

In step 208, the first and second radio frequency device 102, 104 exchange public encryption keys Pka, Pkb. In this embodiment the public keys are elliptic-curve public keys and the key exchange forms part of a Diffie-Hellman key exchange protocol.

In step 210, the first radio frequency device 102 calculates a confirm value Caᵢ=f(Pkaᵢ, Pkbᵢ, Naᵢ, Kᵢ) for i=1, where i indicates the bit of each parameter and Na is a random nonce selected by the first radio frequency device 102. At the same time, in step 212, the second radio frequency device 104 calculates a corresponding confirm value Cbᵢ=f(Pkbᵢ, Pkaᵢ, Nb, Kᵢ) for i=1, where Nb is a random nonce selected by the second radio frequency device 104 and the function is the LE Secure Connections Confirm Value Generation Function.

In step 214, the first and second radio frequency devices 102, 104 exchange the first confirm values Ca₁, Cb₁. In step 216, the first radio frequency device 102 sends the first bit of the nonce Na (i.e. Na₁) to the second radio frequency device 104. In step 218, the second radio frequency device 104 then recalculates Ca₁ locally and compares this to the transmitted confirm value. If the values match, the process proceeds to step 220. If the values do not match, the pairing process is aborted.

In step 220, the second radio frequency device 104 sends the first bit of the nonce Nb (i.e. Nb₁) to the first radio frequency device 102. In step 222, the first radio frequency device 102 then recalculates Cb₁ locally and compares this to the transmitted confirm value. If the values do not match, the pairing process is aborted. However, if the values match, the process repeats steps 210-222 for the next value of i.

Because the passkey K is transmitted using the separately-encrypted advertising packet, it is not known to a man-in-the-middle attacker on the pairing process (because an unauthorised attacker does not have the advertising encryption key). Because the confirm values are a function of the passkey K, a MITM attacker cannot pass the confirm value checks in steps 218 and 222, and thus will not be able to complete the pairing process.

Once all of the bits of the passkey have been used (e.g. 20 bits for a 6-digit passkey) and all of the confirm value checks have passed, the authentication process is completed successfully. The system 100 then proceeds to perform the remainder of the pairing process (e.g. as set out in Bluetooth Core Specification v5.0, Vol 2, Part H, Section 7), e.g. generating one or more cryptographic keys for securing ongoing communication between the first and second radio frequency devices 102, 104.

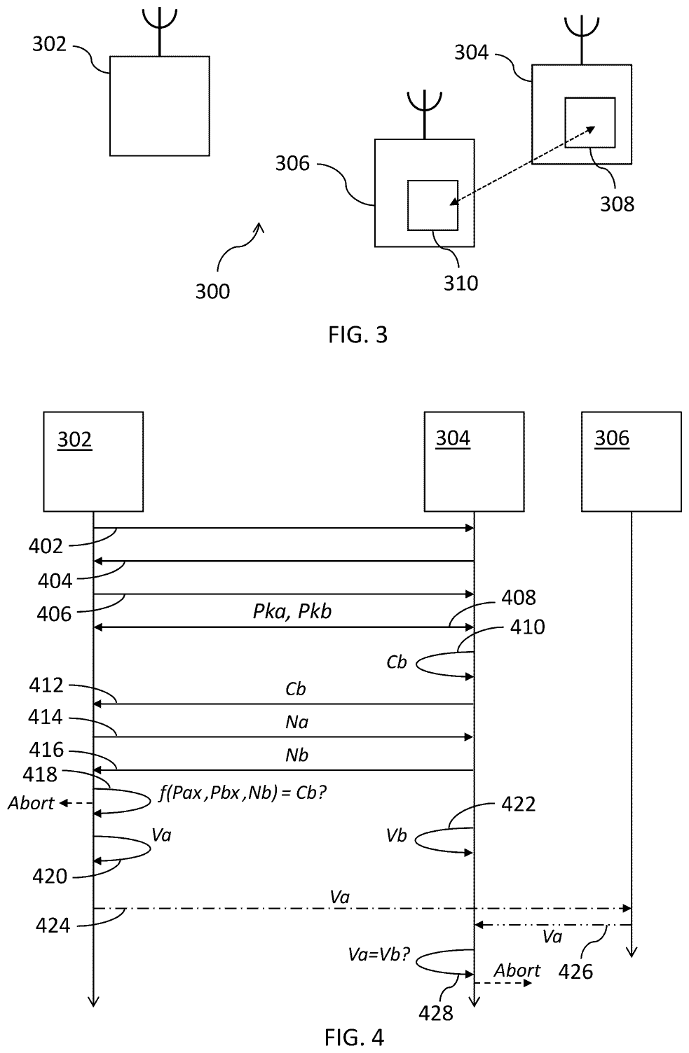

FIG. 3 shows another radio frequency communication system 300 comprises a first radio frequency device 302, a second radio frequency device 304 and a third radio frequency device 306. The first, second and third radio frequency devices 302, 304, 306 are all operable to transmit and receive signals according to a Bluetooth LE wireless communication protocol.

In this embodiment, the first radio frequency device 302 does not feature a user interface (i.e. any user inputs or outputs aside from, potentially, an on/off switch). The second radio frequency device 304 comprises a camera 308 and the third radio frequency device 306 comprises a display 310.

Because the first radio frequency device 302 does not feature a user interface, it may be challenging to establish a fully-authenticated secure communication link between the first radio frequency device 302 and the second radio frequency device 304 (i.e. one that is not vulnerable to Man-In-The-Middle attacks). However, as explained below, the system 300 makes use of encrypted advertising and the interfaces of the second and third radio frequency devices 304, 306 to authenticate a pairing process and mitigate MITM attacks.

This will now be explained in more detail with reference to the flow diagram of FIG. 4.

In a preliminary step 402, the first radio frequency device 302 broadcasts radio frequency signals in which advertising packets are encoded. The advertising packets indicate the availability of the first radio frequency device 302 and include information for establishing a communication link (pairing) with the first radio frequency device 302. The second radio frequency device 304 detects the advertising packet and retrieves the pairing information.

In step 404, the second radio frequency device 304 sends a pair request to the first radio frequency device 302 (using pairing information retrieved from the advertising packet) to initiate a paring procedure.

In step 406, the first radio frequency device 302 provides a positive pair response to the pair request.

In step 408, the first and second radio frequency device 302, 304 exchange public encryption keys Pka, Pkb. In this embodiment, the public keys are elliptic-curve public keys and the key exchange forms part of a Diffie-Hellman key exchange protocol.

In step 410, the second radio frequency device 304 calculates a commitment value Cb=f(Pkax, Pkbx, Nb), where Pkax and Pkbx are the x-coordinates of the public keys, and Nb is a random nonce selected by the second radio frequency device 304.

In step 412, the second radio frequency device 304 transmits the commitment value Cb to the first radio frequency device 302. In step 414 the first radio frequency device 302 transmits a random nonce Na to the second radio frequency device 304 and in step 416, the second radio frequency device 304 transmits a random nonce Nb to the first radio frequency device 302. The first radio frequency device 302 (or a potential MITM attacker) must thus commit to the nonce Na before knowing the nonce Nb.

In step 418, the first radio frequency device 302 recalculates Cb locally and compares this to the transmitted commitment value. If the values match, the process proceeds to step 420. If the values do not match, the pairing process is aborted.

In step 420, the first radio frequency device 302 calculates a confirmation value Va=g(Pkax, Pkbx, Na, Nb) and, at the same time, in step 422 the second radio frequency device 304 calculates a corresponding confirmation value Vb=g(Pkax, Pkbx, Na, Nb), using the LE Secure Connections numeric comparison value generation function.

Because the confirmation values Va, Vb are calculated locally, they cannot be manipulated by a man-in-the-middle attacker on the pairing process. Thus, if the values Va, Vb match the system 300 can be confident that the communication link is authentic. However, in this embodiment, neither the first radio frequency device 302 nor the second radio frequency device 304 features a display, so a user cannot manually compare the values Va, Vb to authenticate the pairing process.

Therefore, in step 424, first radio frequency device 302 broadcasts radio frequency signals in which an encrypted advertising packet is encoded. The encrypted advertising packet contains the confirmation value Va. The content of the advertising packet is encrypted with a symmetric advertising encryption key. This key is not known to the second radio frequency device 304 but is stored to the third radio frequency device 306 during manufacture. As explained above, in other embodiments the advertising encryption key may not be pre-stored and may instead be shared through another communication channel.

Because the third radio frequency device 306 knows the symmetric advertising encryption key, in step 424 the third radio frequency device 306 detects and decrypts the encrypted advertising packet and retrieves the confirmation value Va.

In step 426, the third radio frequency device 306 displays on the display 310 the confirmation value Va, or a graphical symbol in which the confirmation value Va is encoded (e.g. a two-dimensional barcode). The second radio frequency device 304 is then operated to image the display 310 using the camera 308 and to determine the confirmation value Va. Thus the confirmation value Va is relayed to the second radio frequency device 304 using a separately-encrypted advertising packet via the third radio frequency device 306 and therefore cannot be manipulated by a man-in-the-middle attacker on the pairing process. While in this embodiment the second and third radio frequency devices 304, 306 use a camera and a display to transfer the confirmation value Va, this is not essential and in other embodiments other input and output mechanisms known in the art per se may be used to transfer the confirmation value Va.

In step 428, the second radio frequency device 304 compares the confirmation value Va received via the third radio frequency device 306 with the locally-calculated confirmation value Vb. If the values do not match, the pairing process is aborted.

It will be appreciated that aside from the use of encrypted advertising and the third radio frequency device 306 to exchange the confirmation values, and the subsequent automated comparison in step 428, the pairing process is essentially in accordance with the Bluetooth LE Secure Connections Pairing Protocol (Authentication Stage 1=Numeric Comparison) set out at Vol 3, Part H, Section 2 of the Bluetooth core specification v5.0.

If the values Va, Vb compared in step 428 do match, the system 300 proceeds to perform the remainder of this pairing process, e.g. generating one or more cryptographic keys for securing ongoing communication between the first and second radio frequency devices 302, 304.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A radio frequency communication system comprising:
a first radio frequency device and a second radio frequency device arranged to establish a communication link by exchanging radio frequency signals in which data are encoded;
wherein the first radio frequency device is arranged to broadcast a radio frequency signal in which an advertising packet is encoded, the advertising packet comprising authentication information encrypted using an advertising key, and the second radio frequency device is arranged to retrieve the authentication information and use the authentication information to authenticate the communication link.

2. The radio frequency communication system of claim 1, wherein the authentication information comprises an input to a cryptographic authentication process.

3. The radio frequency communication system of claim 2, wherein one or each of the first and second radio frequency devices is arranged to use the authentication information and one or more parameters relating to the communication link in a cryptographic function to produce a cryptographic confirmation value.

4. The radio frequency communication system of claim 1, wherein the authentication information comprises an output of a cryptographic authentication process.

5. The radio frequency communication system of claim 4, wherein the first and second radio frequency devices are arranged to generate locally a confirmation value using one or more parameters relating to the communication link in a cryptographic function, and the confirmation value generated by the first radio frequency device is arranged to be transferred to the second radio frequency device as the authentication information.

6. The radio frequency communication system of claim 1, wherein the first radio frequency device is arranged to provide different authentication information each time a communication link is established and/or periodically.

7. The radio frequency communication system of claim 1, wherein the first and/or second radio frequency device has no user interface arranged for inputting authentication information and/or no user interface arranged for outputting authentication information.

8. The radio frequency communication system of claim 1, wherein the second radio frequency device is arranged to authenticate the communication link automatically.

9. The radio frequency communication system of claim 1, wherein the second radio frequency device authenticating the communication link comprises the second radio frequency device providing one or more user outputs based on the authentication information and receiving one or more user responses.

10. The radio frequency communication system of claim 1, wherein at least some of the radio frequency signals that the first and second radio frequency devices are arranged to exchange to establish the communication link have a carrier frequency in a first frequency range, and the radio frequency signal in which the advertising packet is encoded has a carrier frequency in a second, different frequency range.

11. The radio frequency communication system of claim 1, wherein the first radio frequency device is arranged to broadcast the radio frequency signal in which the advertising packet is encoded broadcast before the first and second radio frequency devices exchange any data for establishing the communication link.

12. The radio frequency communication system of claim 1, wherein the first radio frequency device is arranged to broadcast the radio frequency signal in which the advertising packet is encoded at substantially the same time as the first and second radio frequency devices are exchanging data for establishing the secure communication.

13. The radio frequency communication system of claim 1, wherein the second radio frequency device comprises different radio modules for establishing the communication link and receiving the advertising packet.

14. The radio frequency communication system of claim 1, wherein the advertising decryption key or information for deriving the advertising decryption key is stored to a memory of the second radio frequency device during manufacture or commissioning.

15. The radio frequency communication system of claim 1, comprising a third radio frequency device arranged to receive the advertising packet, decrypt the authentication information and output the authentication information.

16. The radio frequency communication system of claim 15, wherein the third radio frequency device is arranged to forward the authentication information directly to the second radio frequency device.

17. The radio frequency communication system of claim 15, wherein the third radio frequency device is arranged to output the authentication information in a form suitable for a user to forward to the second radio frequency device.

18. The radio frequency communication system of claim 1, wherein the communication link comprises a Bluetooth Low Energy communication link and the advertising packet comprises a Bluetooth Low Energy encrypted advertising packet.

19. A method of operating a radio frequency communication system comprising a first radio frequency device and a second radio frequency device, the method comprising:
the first and second radio frequency devices establishing a communication link by exchanging radio frequency signals in which data are encoded;
the first radio frequency device broadcasting a radio frequency signal in which an advertising packet is encoded, the advertising packet comprising authentication information encrypted using an advertising encryption key; and
the second radio frequency device retrieving the authentication information and using the authentication information to authenticate the communication link.

20. A radio frequency device arranged to:
establish a communication link with another radio frequency device by exchanging radio frequency signals in which data are encoded with the other radio frequency device; and
broadcast a radio frequency signal in which an advertising packet is encoded, the advertising packet comprising authentication information for authenticating the communication link and said authentication information being encrypted using an advertising encryption key.
